(19) United States
(12) Patent Application Publication
(10) Pub. No.: US 2014/0340514 A1
(43) Pub. Date: Nov. 20, 2014

(54) FAST OPTICAL SHUTTERING SYSTEM

(71) Applicant: Compagnie Industrielle des Lasers CILAS, ORLEANS (FR)

(72) Inventors: Regis GRASSER, OLIVET (FR); Aurelien MOREAU, OLIVET (FR)

(73) Assignee: Compagnie Industrielle des Lasers CILAS, ORLEANS (FR)

(21) Appl. No.: 14/276,437

(22) Filed: May 13, 2014

(30) Foreign Application Priority Data
May 14, 2013 (FR) 1301100

(51) Int. Cl. H04N 5/235; H04N 5/225

(52) U.S. Cl. CPC H04N 5/2353; H04N 5/2256; H04N 5/2354
USPC 348/143; 348/367

(57) ABSTRACT

The system (1) has at least one Fabry-Pérot cavity (3) with an adjustable gap (E), of which a gap value known as the nominal value allows a laser beam (4) of corresponding frequency to pass through said Fabry-Pérot cavity (3), controllable piezoelectric actuation means (5A), capable of causing said gap (E) to vary, within a range of gap values including said nominal value, and a control unit (6) to control said actuation means (5A) so that it causes the gap (E) to vary in accordance with a periodic time function.

The present invention relates to a fast optical shuttering system. It also relates to an active observation system comprising a fast optical shuttering system of this kind, in particular for defense and security applications.

Within the scope of the present invention, an active observation system is configured to illuminate a scene from the surrounding area using a laser source, in order to improve the quality of an image of said scene and/or to clearly show some specific details, such as optical sights, for example. For this purpose, said observation system comprises a laser source with a special beam-shaping lens and a receiving camera capable of producing an image of the illuminated scene. One feature of an active system such as the system in question is its capacity to illuminate only a limited part of the space. In order to do this, the camera is sensitive to the entering light for a very short period of time, typically between 0.1 μs and 10 μs. If the laser illumination also uses a short pulse, the combination with the short exposure time of the camera results in a selection of photons that correspond to a fairly limited period of movement. In this case, the image produced corresponds to a part of the space (in distance) relative to the position of the active system (typically from several tens of metres to several hundred). The field of vision can therefore be defined not only in two dimensions (in accordance with the usual plane of vision) but also according to the distance towards the active system, in other words in three dimensions.

In an application of this kind, some lasers require multiple exposures of very short duration in order to reach the energy necessary to form an image with an acceptable signal/noise ratio.

The present invention relates to a fast optical shuttering system that gives any associated optical component, and in particular cameras, a capacity for multiple exposures of short duration.

According to the invention, said fast optical shuttering system is distinctive in that it has:

at least one Fabry-Pérot cavity with an adjustable gap, of which a gap value known as the nominal value allows a laser beam (or pulse) of a corresponding frequency known as the nominal frequency to pass through said Fabry-Pérot cavity;

controllable piezoelectric actuation means, capable of causing said gap to vary, within a range of gap values that includes said nominal value; and

a control unit to control said actuation means so that it causes the gap to vary in accordance with a periodic time function. Said periodic function is preferably sinusoidal.

Rapid changes in the size of the cavity gap (implemented by the actuation means) make it possible for the shuttering function to be performed.

In addition, in order to obtain a very short response time of approximately 1 μs, the fast shuttering system according to the invention operates at the mechanical resonance of the cavity, controlling the piezoelectric actuators with a periodic function, in particular a sinusoidal function. The resonant frequency can be managed by means of the shape and the shape factor of different parts of the Fabry-Pérot cavity. For example, it is possible to obtain a resonance at 5 kHz.

The cavity then becomes transparent to a beam of a given wavelength, only if the size of the gap in the Fabry-Pérot cavity changes to the appropriate corresponding value. This situation can occur several times during each cycle of the periodic control function, preferably sinusoidal, but it lasts for a short time only.

By virtue of these features, the shuttering system according to the invention can open and close at high frequencies (1 kHz to 50 kHz), each opening lasting for a very short time (0.1 μs to 10 μs). Said shuttering system has no optical power and performs a rapidly varying transmission function only.

Said fast shuttering system can be placed in front of the optics of an optical sensor and in particular of a camera, close to the position of the entrance pupil, in order to create a capacity to produce short multiple exposures, for the entering light.

In a first embodiment, said periodic actuation means is configured so as to uniformly modify the spacing between two parallel surfaces of the Fabry-Pérot cavity, in order to cause said gap to vary.

In a second embodiment, said periodic actuation means is configured so as to deform said Fabry-Pérot cavity, in order to cause said gap to vary.

Furthermore, advantageously, said fast optical shuttering system has:

means that make it possible for an operator to adjust the resonant frequency of said Fabry-Pérot cavity; and/or

means that make it possible for an operator to adjust the duration of opening for the nominal frequency and the duration of repetition of opening.

In a particular embodiment, said optical shuttering system has a plurality of Fabry-Pérot cavities which are distributed over a single optical surface, preferably representing an entrance pupil of an optical element and in particular of a camera.

In this case, advantageously, said Fabry-Pérot cavities are configured so that they are controlled independently. In addition, advantageously, said optical shuttering system has a plurality of polarisers, each of which is associated with one of said Fabry-Pérot cavities.

The present invention also relates to an active observation system, of the type that has:

at least one laser source, which is capable of emitting at least one laser beam (or pulse);

a controllable shutter capable of being brought, alternately, into an open position, in which it allows said laser beam to pass, and a closed position in which it prevents said laser beam from passing;

a camera capable of taking an image of a field of vision illuminated by said laser source, through said shutter; and

a control unit that simultaneously controls said laser source, said shutter and said camera.

According to the invention, this active observation system is distinctive in that said shutter comprises a fast optical shuttering system, such as that described above, which is then placed in front of the optics of the camera, close to the position of the entrance pupil, in order to create a capacity to produce multiple short exposures for the entering light.

In a particular embodiment, the entrance pupil of the camera comprises a plurality of sub-pupils, each of which has a Fabry-Pérot cavity.

This last embodiment is particularly well-suited to a polarimetric analysis. This is because each sub-pupil can be connected to a polariser in order to select only a state of polarisation coming from the scene. The analysis of images polarised in this way makes it possible, in particular, to detect hidden objects in the scene.

The present invention also relates to a fast shuttering method, which is distinctive in that:

a Fabry-Pérot cavity is provided, having an adjustable gap, of which a gap value known as the nominal value allows a laser beam of a corresponding frequency known as the nominal frequency to pass through said Fabry-Pérot cavity; and

said gap is caused to vary rapidly, by deformation or movement of at least one surface of the Fabry-Pérot cavity, within a range of gap values that includes said nominal value, according to a periodic time function.

The figures of the accompanying drawings will give a clear understanding as to how the invention can be achieved. In these figures, identical reference signs denote like elements.

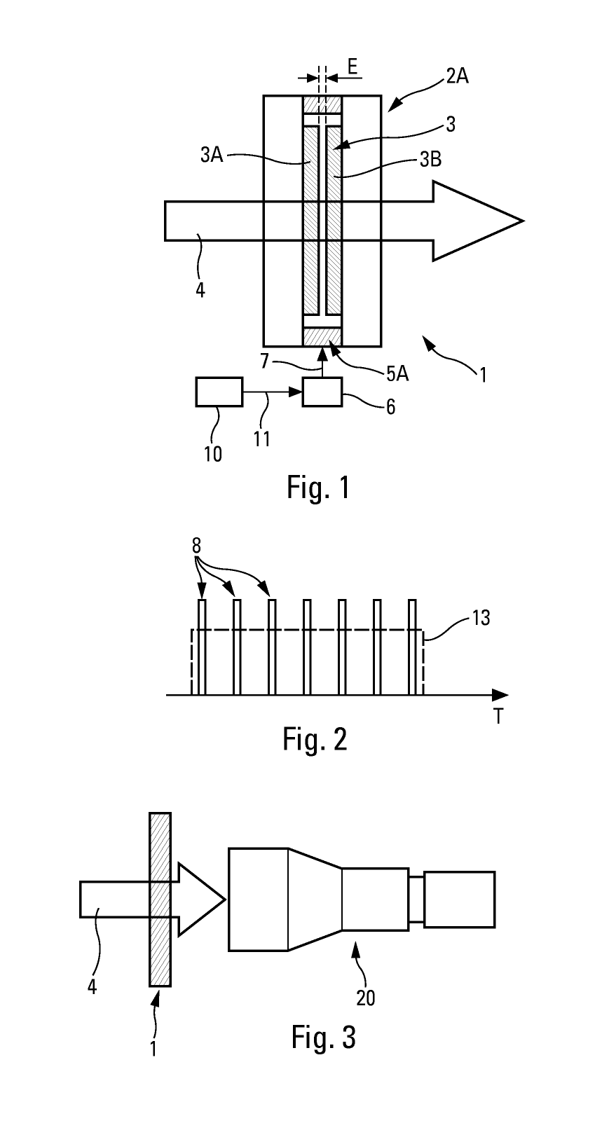

FIG. 1 is a very schematic illustration of a fast shuttering system according to the invention.

FIG. 2 shows some periods of opening of the shuttering system, associated with an exposure period of a camera.

FIG. 3 shows a camera that is associated with a fast shuttering system according to the invention.

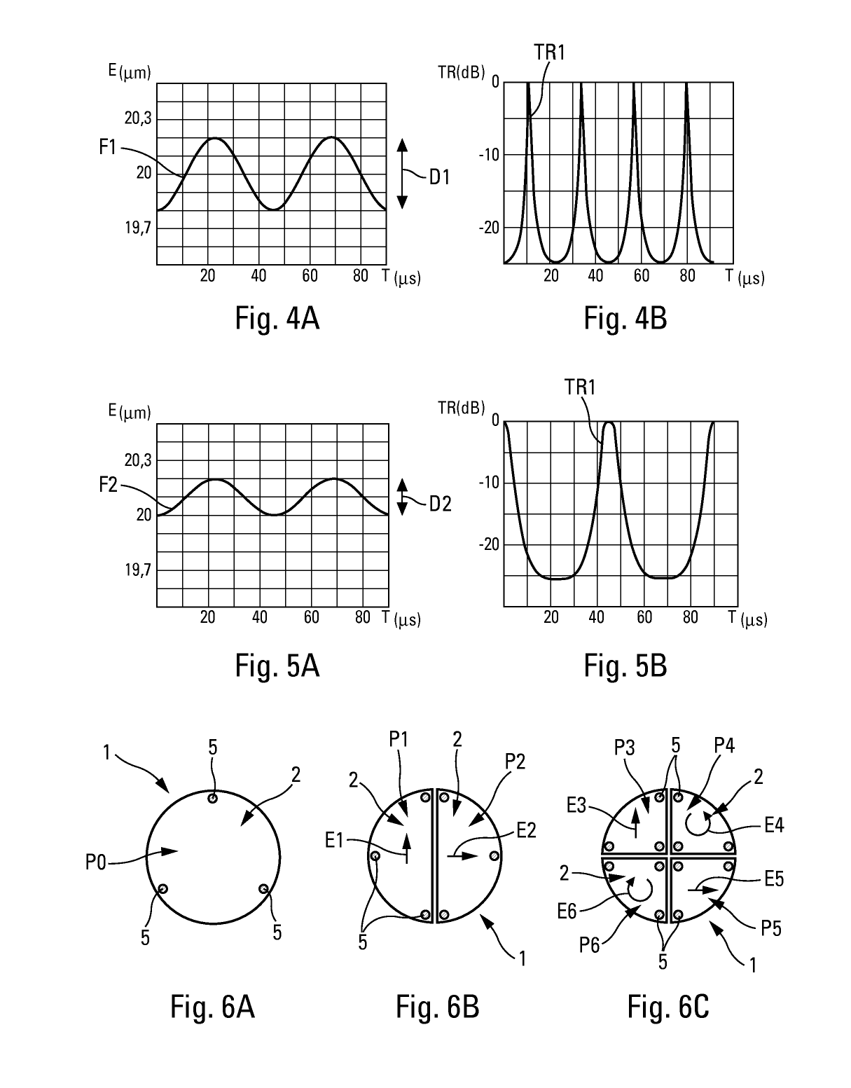

FIGS. 4A and 4B are graphs explaining a first method of adjusting a fast shuttering system according to the invention.

FIGS. 5A and 5B are graphs explaining a second method of adjusting a fast shuttering system according to the invention.

FIGS. 6A, 6B and 6C show different embodiments of a fast shuttering system according to the invention.

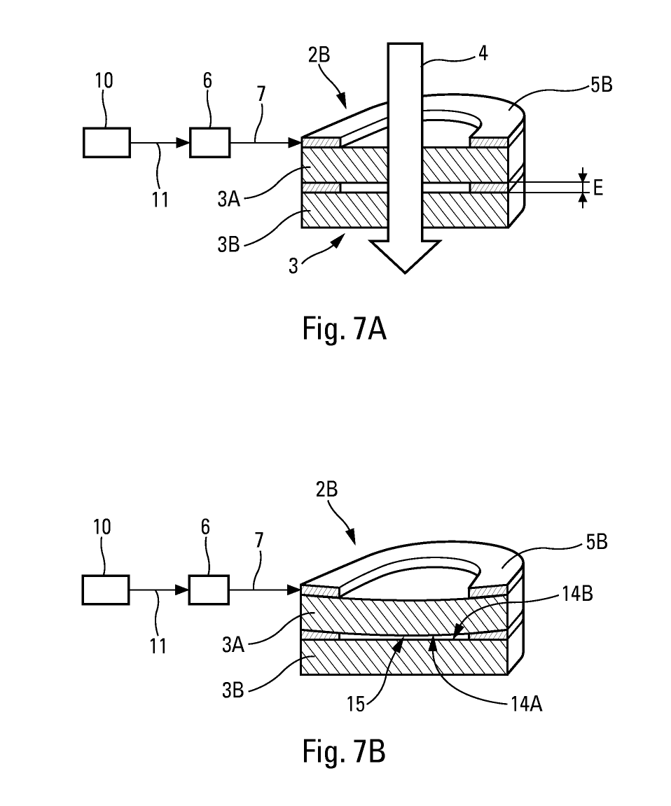

FIGS. 7A and 7B are very schematic illustrations of a particular embodiment of a fast shuttering system according to the invention.

The fast optical shuttering system 1 according to the invention and shown schematically in FIG. 1 is intended to give a capacity for multiple brief exposures to any associated optical element and in particular to a camera 20 (FIG. 3), placed between this system 1 and a place from which a laser beam is emitted (in particular a scene returning a beam generated by a laser source).

According to the invention, this fast optical shuttering system 1 has at least one assembly 2A, 2B comprising:

a Fabry-Pérot cavity 3 of a standard type. This cavity 3 comprises, usually, two partially reflective planar surfaces 3A and 3B, with high reflection coefficients. Said cavity 3 has an adjustable gap E (corresponding to the gap between the two surfaces 3A and 3B), of which a gap value E0 known as the nominal value allows a laser pulse 4 of a corresponding frequency known as the nominal frequency to pass through said Fabry-Pérot cavity, as detailed below; and

piezoelectric actuators 5A, 5B which can be controlled and which are capable of causing said gap E to vary rapidly, in a range D1, D2 of gap values E comprising said nominal value E0.

In the embodiment shown in FIG. 1, said piezoelectric actuators 5A of the assembly 2A are configured to cause the spacing (defining the gap E) between the two parallel surfaces 3A, 3B of the Fabry-Pérot cavity 3 to vary, in parallel and uniformly. In this embodiment shown in FIG. 1, the spacing between the two surfaces 3A and 3B of the cavity 3 always remains uniform. However, another embodiment (producing a deformation of the Fabry-Pérot cavity 3) is also possible, as detailed below with reference to FIGS. 7A and 7B.

Said system 1 also has, according to the invention, a control unit 6 which is connected by means of a link 7 to said piezoelectric actuators 5A, 5B and which is formed so as to control said actuators 5A, 5B in such a way that they cause the gap E to vary according to a function F1, F2 which is periodic over time. Preferably, this periodic function F1, F2 is sinusoidal.

It is known that the transmission of light in a Fabry-Pérot cavity 3 is very wavelength sensitive. Depending on the value of the gap E, the transmission for a given wavelength can vary from no transmission to a complete transmission. By modifying the size of the gap E of the Fabry-Pérot cavity 3, it is therefore easy to control the transmission for a specific wavelength. Rapid changes in the size of the gap E thus make it possible to implement a shuttering function.

However, the mechanical inertia of the assembly 2A, 2B allows only a response time of approximately 1 ms. In order to obtain a much shorter response time of around 1 μs, the system 1 operates at resonance, controlling the piezoelectric actuators 5A, 5B with a periodic function that is preferably sinusoidal. The resonant frequency can be managed by means of the shape and the shape factor of different parts of the Fabry-Pérot cavity 3.

By virtue of these features, the shuttering system 1 according to the invention is able to open and close at high frequencies (1 kHz to 50 kHz). Each opening 8 (FIG. 2) lasts a very short time (0.1 μs to 10 μs). Said fast optical shuttering system 1 has no optical power and performs only a rapidly changing transmission function.

The Fabry-Pérot cavity 3 is therefore configured so as to become transparent to the relevant wavelength of the laser pulse 4, only if the size of the gap E changes to the nominal value E0 representative of that wavelength. This situation can occur several times during each cycle of the sinusoidal function F1 and F2, but it lasts for only a short time. The fact of operating at resonance thus allows an opening time of 1 μs or less for the system 1.

Furthermore, said fast optical shuttering system 1 also has adjustment means 10 which are, for example, connected by means of a link 11 to the control unit 6 and which make it possible for an operator to adjust, in particular, the resonant frequency of said Fabry-Pérot cavity 3, the nominal frequency and also the duration of opening for the nominal frequency and the duration of repetition of opening.

More specifically:

the adjustment of the resonance parameters of the cavity allows the duration of opening (or time during which the optical cavity 3 allows the passage of the monochrome laser beam (or laser pulse 4) to be adjusted; and

the shape and the shape factor of the different parts of the system 1 allow the frequency to be adjusted.

The system 1 can therefore produce a function of multiple exposures of short durations.

If the cavity 3 is adjusted so that there is total transmission of the laser pulse 4 at the rest value (median value) of the control function F1, excitation of the resonant frequency prevents the passage of this laser pulse 4 for most of the time T, but allows it to pass at the rest value (nominal gap of 20 μm).

This situation is shown in FIGS. 4A and 4B, which show, respectively:

the variation in the gap E of the cavity 3 (expressed in μm) as a function of time T (expressed in μs), which has a sinusoidal function F1; and

the corresponding transmission TR1 (expressed in dB) of the laser pulse 4, through the assembly 2, as a function of said time T.

In this example, for which the cavity 3 is adjusted to allow the laser pulse 4 to pass at the rest value of the function F1 (where time T is approximately: 12 μs, 34 μs), opening takes place approximately every 20 μs (duration of repetition of opening) and it lasts less than 1 μs (duration of opening).

If the cavity is adjusted so as to have no transmission at the rest value, excitation of the resonant frequency allows the laser beam to pass through the cavity 3 only when it reaches the appropriate gap value (20 μm).

This situation is represented in FIGS. 5A and 5B, which show, respectively:

the variation in the gap E of the cavity 3 (expressed in μm) as a function of time (expressed in μs), which has a sinusoidal function F2; and

the corresponding transmission TR2 (expressed in dB) of the laser pulse 4 through the assembly 2 as a function of said time T.

In this example, for which the cavity 3 is adjusted to allow the laser pulse 4 to pass when the function F2 reaches the minimum value (where time T is approximately: 0 μs, 45 μs), the opening takes place more slowly, but it lasts longer, almost 5 μs.

The present invention provides for the use of a high-finesse (very wavelength-selective) Fabry-Pérot cavity to transform a mechanical oscillation with a long duration (typically a millisecond or a tenth of a millisecond) into a much faster shuttering time (typically a microsecond).

Furthermore, in a particular embodiment shown in FIGS. 7A and 7B, said piezoelectric actuators 5B of the assembly 2B are configured to produce a deformation of the Fabry-Pérot cavity 3.

In FIG. 7A, the cavity 3 has the appropriate gap E allowing the laser beam 4 to pass (with a parallel arrangement of the two surfaces 3A and 3B).

In contrast, in the situation shown in FIG. 7B, the piezoelectric actuators 5B have been actuated in such a way as to deform the cavity 3 (by acting on the surface 3A). This deformation (indicated by an arrow 15) means that the inner face 14A of the surface 3A (opposite the inner face 14B of the surface 3B) is slightly rounded and convex, which modifies the gap between the two surfaces 3A and 3B which is no longer constant. Thus, the spacing between the two surfaces 3A and 3B is different from the nominal gap, at least at the point (arrow 15) at which the laser beam 4 passes. Said laser pulse 4 is therefore reflected and cannot pass through the Fabry-Pérot cavity 3.

In a simplified embodiment, the system 1 has a single assembly 2 which is arranged at an entrance pupil P0, as shown schematically in FIG. 6A.

As indicated above, by being placed in front of the optics of the camera 20, close to the position of the entrance pupil, the fast shuttering system 1 is able to create a capacity to produce short multiple exposures for the laser beam 4.

In a particular embodiment, said optical shuttering system 1 has a plurality of assemblies 2 (each comprising a Fabry-Pérot cavity 3) which are distributed over an entrance pupil, in particular that of a camera 20. In this instance, said Fabry-Pérot cavities 3 are configured so that they are controlled independently. In addition, said optical shuttering system 1 has a plurality of polarisers (not shown), each of which is associated with one of said Fabry-Pérot cavities 3.

The architecture of the system 1 is therefore divided into a plurality of sub-pupils, for example:

into two similar sub-pupils P1 and P2, as shown in FIG. 6B with respective polarisations E1 and E2; or

into four similar sub-pupils P3 to P6, as shown in FIG. 6C with respective polarisations E3 to E6.

The different elements 3 and 5 can be controlled independently to open one sub-pupil or the other as necessary.

This embodiment shown in FIGS. 6B and 6C is particularly well suited to a parametric analysis. With two or four sub-pupils, each sub-pupil can therefore be connected to a polariser in order to select only a state of polarisation coming from the scene. The analysis of images polarised in this way makes it possible for objects hidden within the scene to be detected, particularly where these objects have a different polarisation from natural elements (for example the vegetation in the scene).

In a preferred application, said system 1 thus forms part of an active observation system (not shown). This active observation system includes:

at least one laser source, which is capable of emitting at least one laser pulse 4;

said system 1 which is capable of being brought, alternately, into an open position, in which it allows said laser pulse 4 to pass, and a closed position in which it prevents said laser pulse 4 from passing;

a camera 20 that is capable of taking a picture of a field of vision illuminated by said laser source, through said system 1; and

a control unit that simultaneously controls said laser source, said system and said camera.

In this case, the fast shuttering system 1 is placed in front of the optics of the camera 20, close to the position of the entrance pupil, in order to create a capacity to produce multiple short exposures, for the laser beam 4, as shown in FIG. 3.

The camera 20 is preferably exposed during an exposure time 13 which is such that it contains several openings 8 of the system 1 and therefore several successive exposures to the laser beam 4 (emitted by the laser source and reflected by the scene to be observed), as shown schematically in FIG. 2, so that the camera 20 can receive the energy needed to form an image with a satisfactory signal/noise ratio.

It will be noted that, by virtue of the invention, the following can be used for the active system:

any type of camera; and

in particular, a semiconductor type of laser source, which is reliable, can be incorporated easily, and costs less.

1. Fast optical shuttering system, said system (1) having:
at least one Fabry-Pérot cavity (3) having an adjustable gap (E), of which a gap value known as the nominal value allows a laser beam (4) of a corresponding frequency known as the nominal frequency to pass through said Fabry-Pérot cavity;
controllable piezoelectric actuation means (5A, 5B), capable of causing said gap (E) to vary, within a range of gap values that includes said nominal value; and
a control unit (6) to control said actuation means (5A, 5B) so that it causes the gap (E) to vary in accordance with a periodic time function (F1, F2), said Fabry-Pérot cavity (3) being transparent to the laser beam (4) only when the gap (E) changes to said nominal gap value.

2. System according to claim 1, wherein said piezoelectric actuation means (5A) is configured so as to uniformly modify the spacing between two parallel surfaces (3A, 3B) of the Fabry-Pérot cavity (3), in order to cause said gap (E) to vary.

3. System according to claim 1, wherein said piezoelectric actuation means (5B) is configured so as to deform said Fabry-Pérot cavity (3), in order to cause said gap (E) to vary.

4. System according to claim 1, wherein said periodic function (F1, F2) is sinusoidal.

5. System according to claim 1, wherein it has means (10) that make it possible for an operator to adjust the resonant frequency of said Fabry-Pérot cavity (3).

6. System according to claim 1, wherein it has means (10) that make it possible for an operator to adjust the duration of opening for the nominal frequency and the duration of repetition of opening.

7. System according to claim 1, wherein it has a plurality of Fabry-Pérot cavities (3) which are distributed over a single optical surface.

8. System according to claim 7, wherein said Fabry-Pérot cavities (3) are configured so that they are controlled independently.

9. System according to claim 7, wherein it has a plurality of polarisers, each of which is associated with one of said Fabry-Pérot cavities (3).

10. Active observation system of a type that has:
at least one laser source, which is capable of emitting at least one laser beam;
a controllable shutter capable of being brought, alternately, into an open position, in which it allows said laser beam to pass, and a closed position in which it prevents said laser beam from passing;
a camera (20) capable of taking an image of a field of vision illuminated by said laser source, through said shutter; and
a control unit that simultaneously controls said laser source, said shutter and said camera, wherein said shutter comprises a fast optical shuttering system (1), such as that specified under claim 1.

11. System according to claim 10, comprising a fast optical shuttering system (1), wherein said optical surface having a plurality of Fabry-Pérot cavities (3) represents the entrance pupil of the camera (20).

12. Fast shuttering method, wherein:
a Fabry-Pérot cavity (3) is provided, having an adjustable gap (E), of which a gap value known as the nominal value allows a laser beam (4) of a corresponding frequency known as the nominal frequency to pass through said Fabry-Pérot cavity (3); and
said gap (E) is caused to vary, by deformation or movement of at least one surface (3A, 3B) of the Fabry-Pérot cavity (3), within a range of gap values that includes said nominal gap value, according to a periodic time function (F1, F2), said Fabry-Pérot cavity (3) being transparent to the laser beam (4) only when the gap (E) changes to said nominal gap value.
